(19) United States
(12) Patent Application Publication
(10) Pub. No.: US 2008/0060336 A1
(43) Pub. Date: Mar. 13, 2008

(54) Rotovibrating device applicable to knocking down rod headers of harvesting machines

(75) Inventor: Pablo Martin Bonadeo, Santa Fe (AR)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Los Olivares de Venado Tuerto S.A.

(21) Appl. No.: 11/530,844

(22) Filed: Sep. 11, 2006

(51) Int. Cl. A01D 46/00

(52) U.S. Cl. 56/330

(57) ABSTRACT

A rotovibrating device applicable to the knocking down rod headers of harvesting machines, rendering a much better yield to that of other harvesting machines that use the rotovibrating devices known today, being harvesting machines comprising: a frame holding the rotating headers or rollers (2), each one having a vertical axle with which a plurality of rods (3) are radially in contact; said rods being capable of being in physical contact with the branches of the plant to be harvested; comprising at least three eccentric weights (9) capable of turning on independent axles (8), and being laid on equidistant vertexes (7) of the unit that supports the weights (6); and said eccentric weights (9) are in connection with respective crowns (Ci), which receive the movement from their pertinent pinions (Pi) located on the axle (11) of the turning header or roller and the weight (9) support unit (6); having a brake system that is capable of braking the support unit (6) and the header (2) and thus attaining the rotation of the weights (6) on their turning axles (8).

### FIELD OF THE INVENTION

This invention consists of a rotovibrating device applicable to the knocking down rod headers of harvesting machines, rendering a much better yield to that of other harvesting machines that use the rotovibrating devices known today.

Preferably, this harvesting machine is used to harvest olives or oranges, although in practice it could also be used for the harvesting of other bush-like crops.

### BACKGROUND OF THE INVENTION

From time immemorial, especially at the Mediterranean basin, man used to harvest the olive by using the so-called “knocking-down” technique, which involved the knocking of the branches by hand in order to make the fruits fall off and, once on the ground, the collection of those fruits.

One of the hand devices used for this is described in the U.S. Pat. No. 5,099,637 (Drusiani) published on Mar. 31, 1992, which describes a device similar to a rake, although its teeth are covered by a padding material that makes it possible to harvest the olives without causing any harm.

These “knocking-down” techniques, even though still used at present, are reasonably applicable to small harvesting surfaces. In fact, it is very common in certain European countries to find small producers that have only a few hectares of land where they harvest olives and, due to the reduced number of plants, it is possible to use this harvesting technique.

Therefore, large-scale harvesting of olives calls for the use of some mechanical assisting medium tending to ease production. However, as those large harvesting surfaces are uncommon, due to the olive's low yield as compared to other crops (which usually leads to its replacement), other harvesting machines initially designed for other crops are adapted to harvest olives. The most usual example is that of coffee or grape harvesting machines, or fruit harvesting machines, on which certain adaptations are made so that they may be used on this plant. Obviously, none of them provides an adequate solution because the olive tree has clearly defined characteristics different from those of coffee or fruit plants.

There are in the prior art several patents involving fruit or coffee harvesting machines. We will simply provide the following examples of U.S. patents: U.S. Pat. No. 5,904,034 (Youman, et al.) published on May 18, 1999, U.S. Pat. No. 4,077,193 (Diggs Mar. 7, 1978), U.S. Pat. No. 4,329,836 (Scudder) dated May 18, 1982, U.S. Pat. No. 4,860,529 (Peterson et al.) dated Aug. 29, 1989, U.S. Pat. No. 4,974,404 (Korthuis, et al.) of Dec. 4, 1990, U.S. Pat. No. 5,027,593 (Korthuis, et al.) of Jul. 2, 1991, U.S. Pat. No. 5,161,358 (Crunkelton) dated Nov. 10, 1992, U.S. Pat. No. 5,220,775 (Vogel, et al.) dated Jun. 22, 1993 and U.S. Pat. No. 5,421,149 (Littau) of Jun. 6, 1995. Said patents disclose the use of brushes or “knocking down” headers carrying multiple “fingers” or “rods” radially arranged onto the axle of the brushes, which are propelled by an engine that makes them turn. Once in movement, these “brushes” or “headers” get closer to the plant to be harvested causing the “rods” or “fingers” to softly knock the branches, thus leading to the orderly shaking of those branches and, without breaking them, and making the fruits fall off on the ground.

This invention involves the development of a technique and an experimental rotovibrating device to be particularly applied to the olive tree, and to other crops generally, using a machine that is capable of respecting the fundamental principles in view of which it has been created:
A mounting machine (arch over harvesting line). This is due to the fact that it complies with the premise of being more efficient at the time of collection of the fruits and being a more efficient close-capture system, which avoids losses, as compared to a lateral operation machine, and reduces costs, due to the fact that the need for two rides, one for each side of the tree, is avoided.
The machine must have a size that will enable work on trees of maximum 4 m wide and 4.6 m high.
The machine should be able to be transported in special carts, respecting applicable legal provisions, of no more than 3.9 m wide and 4.5 m high.

Harvesting headers must be designed in such a way so as to allow for harvesting and avoid harm to plants and trunks, thus preventing damage to the fruit. In addition, said headers are designed so as to adapt themselves to the top of the trees and work inside the top.

The machine is to be adapted to the different forms of agronomic operation in trees, according to the kind of pruning: for example, cup-like, cone-like, free type, or in the various types of densities in plants, whether it be in intensive cultivation (200 to 400 plants per ha.) or superintensive (more than 400 plants per ha.).

### PURPOSE OF THE INVENTION

One object of this invention is a rotovibrating device applicable to knocking down or hitting rod harvesting machine, having headers or brushes that contain a plurality of rods or “hairs” radially arranged onto the axel of said brushes and parallel to each other.

This invention uses a particular rotovibrating device that comprises a unit supporting eccentric or decentralized weights, said unit preferably having the shape of a star and positioned over the rod header, turning at an angular speed of about 5 to 6 RPM. Likewise, the axle of each eccentric weight will turn at an angular speed of about 200 to 300 RPM when in operation.

The rotovibrating device is driven by an hydraulic engine that will make the star tree turn and the rod header contains additional toothed pinions and is braked by an external medium during operation. In turn, said tree transmits its movement through chains of rollers to crown wheels attached to 3 independent axles, to which the eccentric weights are attached, which weights will move when said crowns turn. The relation between the number of teeth in the pinions (24 teeth) and the number of teeth in the crowns (18 teeth) is the same in the three axels that carry the weights and that are in synchronicity, i.e. they have the same angular relative position between a weight and the next one at all times during rotation so that their moments achieve the maximum scope at the same time.

Should the star-shaped unit rotate around its turning center, it will make the chains to be motionless, thus acting as if they were a stiff element and hence they will prevent the weights they carry from turning on their respective axles. The weights, due to centrifugal force, will be located at the farthest point of the star turn axle.

If the star-shaped unit is braked by an external medium, such as a brake disk, the weights will start to turn around their turning center at a certain angular speed. The more braked the start-shaped unit works, the less angular speed turning value it will have, thus the angular speed value of the weights it carries at its vertexes will increase.

Part of the energy provided by the hydraulic engine is used to make the star and the brush turn, and another part is used to make the weights rotate, thus the rods or fingers oscillate.

The energy absorbed by braking shall be delivered to the weights or masses, which will turn on their axels and shall impart the knocking movement to the rods; the movement of the rod will be a forward and backward acceleration movement, in the direction of the rotation thereof. Therefore, if the star is completely braked, all the energy will be invested in turning the weights, thus the knocking force will be maximum.

On the other hand, if the brake of the star is completely released, the angular speed will be maximum and thus the angular speed of the weights will be zero (staying still or without turning on their axels, at the farthest position from the turning center); the brushes turn at the speed of the star, but without knocking (due to the fact that the weights are at a rest). In intermediate braking solutions, intermediate values are obtained.

The braking is usually adjusted so that the turning speed of the brushes achieve a tangential speed value equal to the forward motion speed of the machine, and this is obtained with W2=5 to 6 RPM.

### BRIEF DESCRIPTION OF THE DRAWINGS

FIG. 1 shows a front view of the olive harvesting machine proposed, wherein the harvesting rod rollers or headers can be clearly seen.

FIG. 2 offers a first perspective view of the harvesting machine of FIG. 1.

FIG. 3 offers a second perspective view of the harvesting machine of FIG. 1.

FIG. 4 shows a first perspective overview of the preferred mounting of the support unit

having the shape of a star located over each harvesting rod header.

FIG. 5 shows a second perspective view of the star-shaped support unit and the supported elements;

FIG. 6 shows a plan view of the star-shaped unit and the weights connected to the ends of its rays;

FIG. 7 shows a lateral view of the star-shaped unit and the driving devices thereof and of the supported parts;

FIG. 8 shows the tensions involved in one of the eccentric weights at the time the star-shaped unit is stopped;

FIG. 9 is a inverted lateral view of the devices that make the star and the weights turn;

FIG. 10 is a plan view of the star-eccentric weighs scheme and the directions of the maximum moments for each of the said weights.

FIGS. 11 and 12 show the rod headers in open and close positions, respectively.

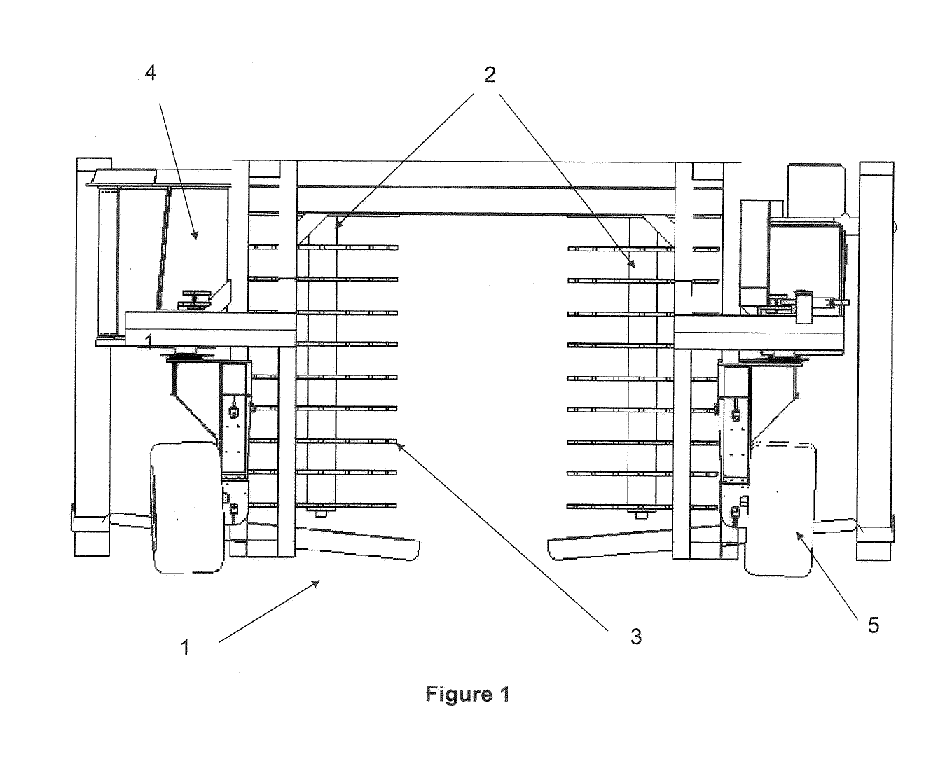

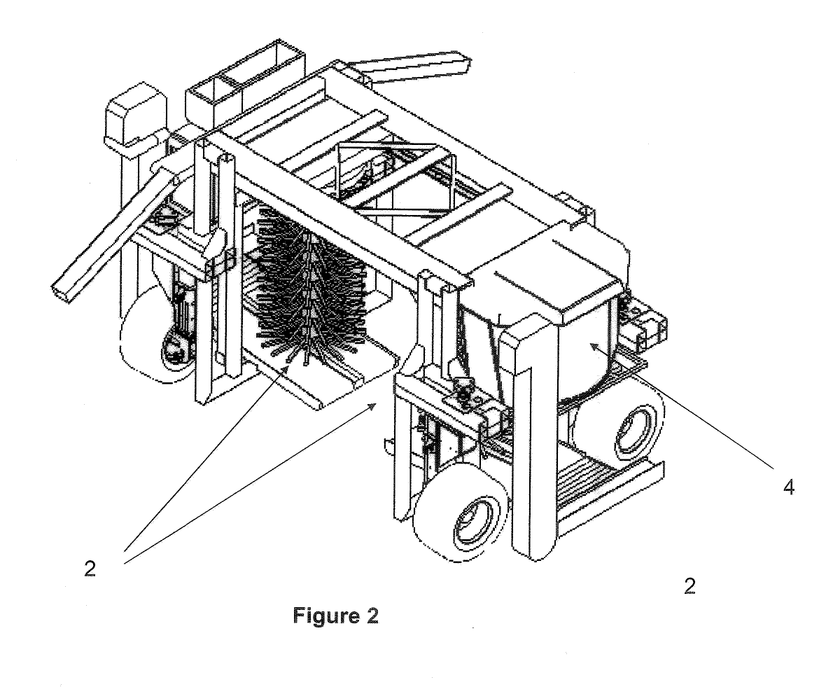

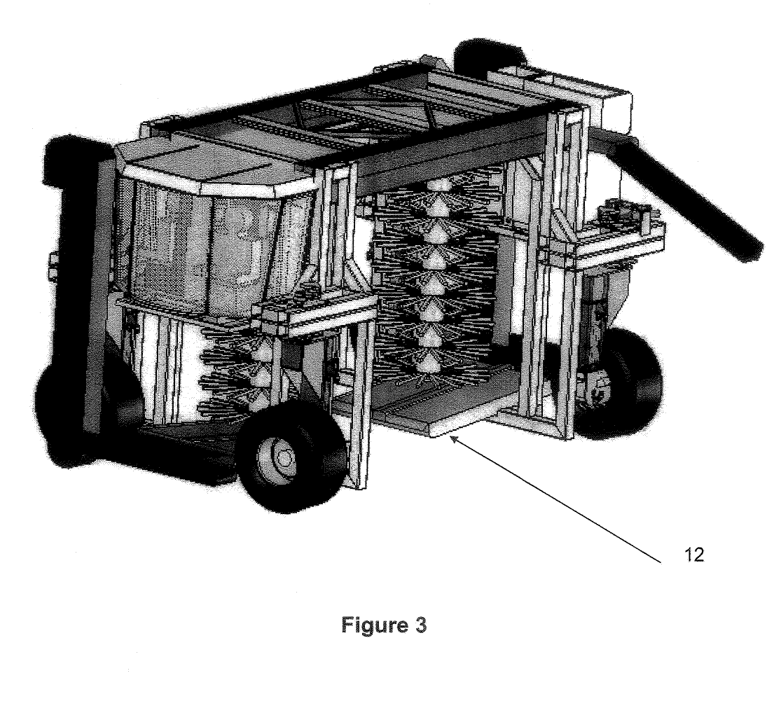

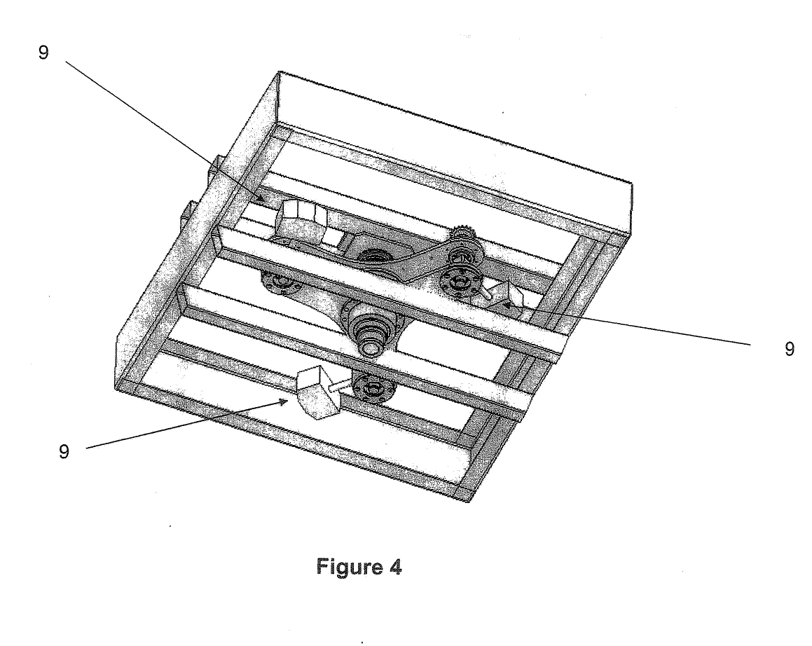

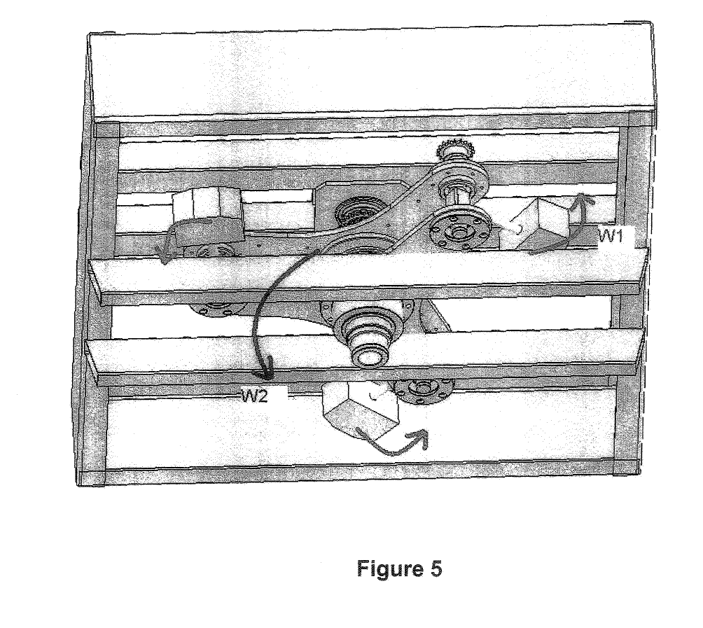

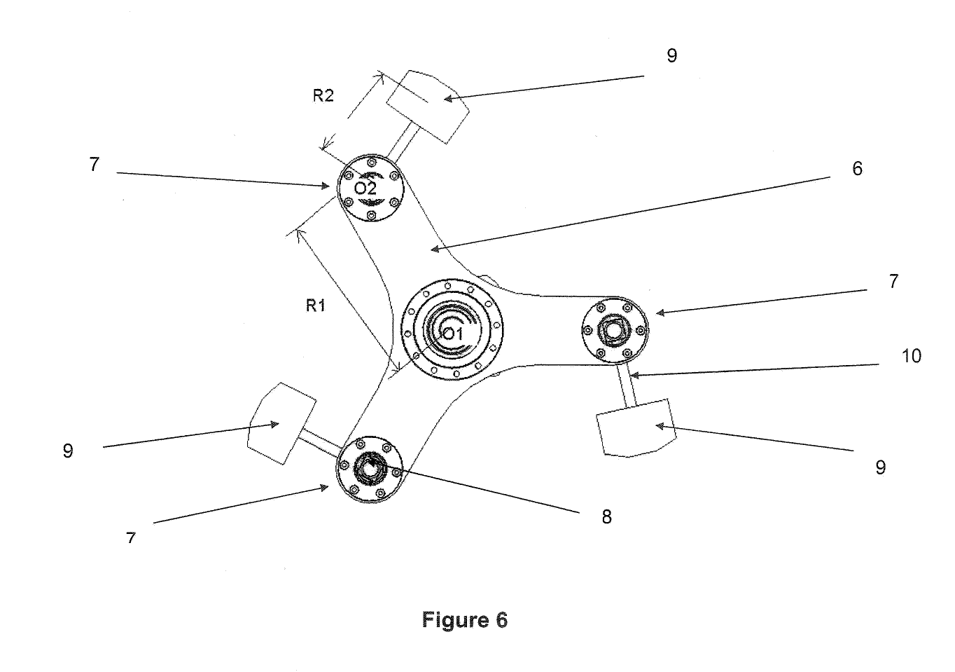

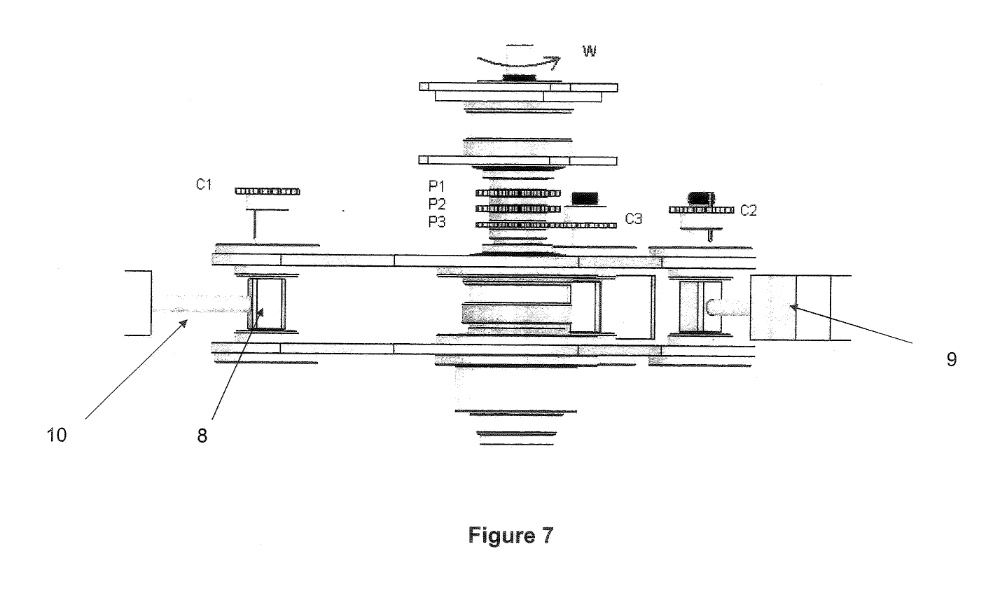

For information purposes only, the figures include the same reference numbers for the same elements in this machine.

### DETAILED DESCRIPTION OF A PREFERRED EMBODIMENT OF THE INVENTION

In full agreement with all what has been illustrated so far, we can see that the harvesting machine 1, comprises at least a couple of headers or rollers 2 with rods 3, an operating cab 4 having room to accommodate two persons, one for the driver and the other for the one in charge of the harvesting system, and moving means or wheels 5.

As it can be seen, said headers or rollers 2 are arranged parallel to each other, and rods 3 are arranged radially around said headers. When turning, said headers 2 will make rods 3 knock the branches of the trees to be harvested and the fruits fall off.

Said knocking movement is essential to achieve the falling off of the tree fruits and an efficient harvesting; to that end, the top end of the headers 2 comprises a support unit preferably having the shape of a star 6, comprised by two parallel plates, between which the turning axles 8 of the respective eccentric weights 9 fasten on their far-end vertexes; such weights support the said turning axle through a preferably tubular part 10. Each one of said eccentric masses 9 in a number of three in the preferred embodiment, shall be subject to a W1 rotation speed.

The rotation of the masses are achieved thanks to axle 8 thereof being coupled to the respective crowns C1, C2 and C3 and the latter being coupled to pinions P1, P2 and P3, which will be set in motion thanks to the turning movement of axle 11 of the header or roller 2.

Each rod 3 is attached to the header so that each of the said rods can, because of their extension, oscillate as they rotate, defining a double action on the branches: not only does the machine knock them while turning, but it also shakes them with its vibration, thus remarkably improving the harvesting yield.

During operation, the operator starts the engine that propels the machine and provides power to the pumps and commands that, among other functions, cause axle 11 to turn, thus causing headers or rollers 2 and the star-shaped support unit 6 to turn as well.

By using the “mouth” defined by the said two rods or headers 2, the operator steers the machine 1 so as to place itself in front of the first plant, thus placing it between both rollers or headers. When the rotating rods 3 get in contact with the tree branches, they hit the branches and at the same time they make an additional shaking movement that sensibly improves yield. Improved yield is to be understood as the capacity of the machine to reap off a larger number of fruits from the plant and keep them at a reachable distance, thus avoiding the possibility of losing the ones falling on the ground.

Below the said rollers, collecting trays 12 prevent the fruits from reaching the ground and, because of their pitch, they carry them to the lower part of the machine where traditional collecting devices are found for later treatment.

Motive power is delivered by a diesel motor that actuates the steering box that provides the necessary mechanical force for the operation of three hydraulic pumps. One of them corresponds to the hydrostatic transmission system, another to the general operation of hydraulic motors and cylinders, and the third one controls a double pump that operates the harvesting headers and rotovibrating devices of this invention.

The mechanical braking system of the support unit is performed by an hydraulic brake, the axle is attached to a toothed pinion which, by means of a chain, moves an hydraulic engine that exercises a counter-pressure to the system, thus braking the whole mechanism. A second option would be the use of disk brake, similar to those used in automobiles.

If the forward motion speed of the machine is equal to the tangential speed of the brush, equal in module but in the opposite direction, the resulting speed of the brush end as regards the ground and thus as regards the plant will be null, and hence the brush will not drag the plant. This means that the brush penetrates the plant but does not crash it and will not collide the plant.

Preferably, rods 3 are made of a polyamide center, covered by rubber so as to avoid bruising the olives; the rods are arranged in a radial manner every 15 degrees at a horizontal level, thus amounting to a total of 24 rods per level, affixed to an aluminum structure in contact with the main axle. The different levels of the rods may be placed apart from one another between 7 cm and 15 cm, according to the density of rods required by the various kinds of crops.

As it can be seen in the figures attached hereto, the central axle 11 of the header and the star-shaped unit 6 that is positioned over header 2, will rotate at a “W2” angular speed of about 5 to 6 RPM; likewise, the axle of each weight will rotate at a “W1” angular speed of about 200 to 300 RPM; “m” being the mass of weight 9; 01 being the turning center of the star-shaped unit, 02 being the turning center of weight 9, R1 being the turning radius of the star-shaped unit 6 and R2 being the turning radius of weight 9.

The device is driven by an hydraulic engine which makes the tree containing toothed pinions P1, P2 and P3 (generally referred to as Pi) rotate at an angular speed of “W” and turning center 01. Said tree transmits it by means of the roller chains (not shown) to crown wheels C1, C2 and C3 (generally referred to as Ci) affixed to 3 independent axles and with a turning center 02, to which eccentric weights 9 are attached, which will set in motion when crowns C1, C2 and C3 rotate.

Since the relation between the number of teeth in the pinions Pi (24 teeth) and the number of teeth in the crowns Ci (18 teeth) is the same in the three axels 12 that carry the weights 9, said weights rotate at the same “W1” angular speed, being in synchronicity, i.e. they have the same relative angular position during the whole turning moment thereof.

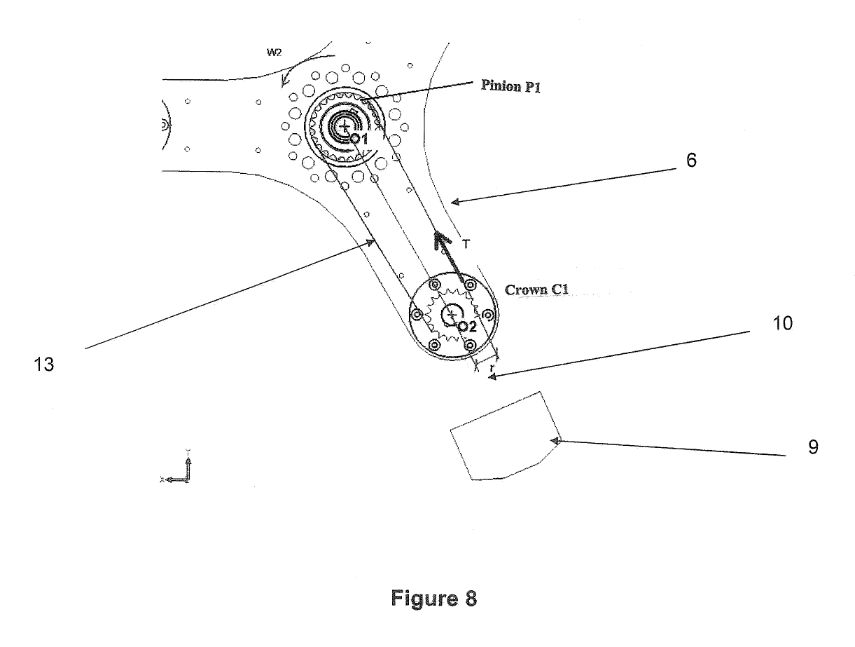

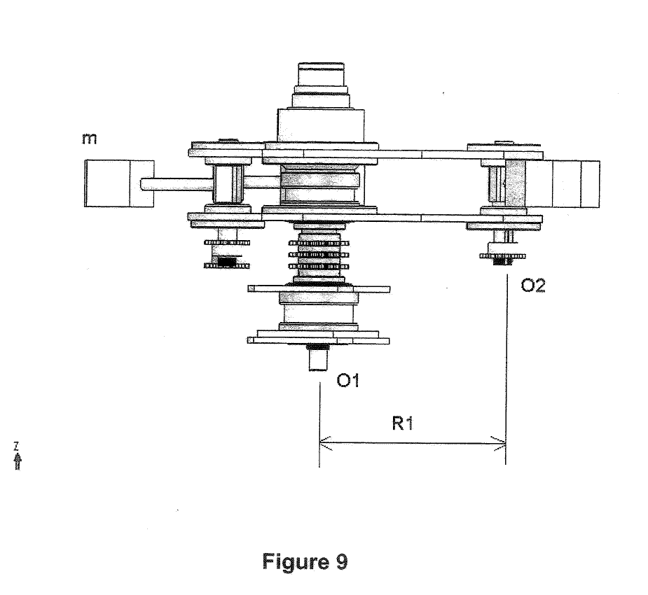

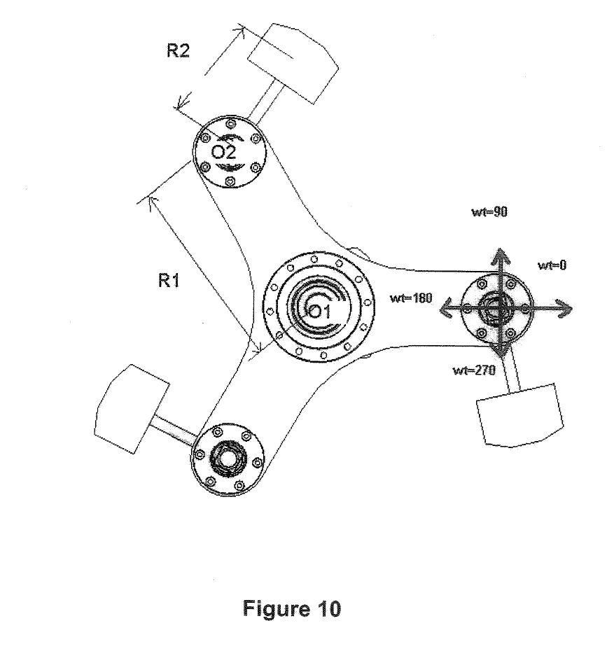

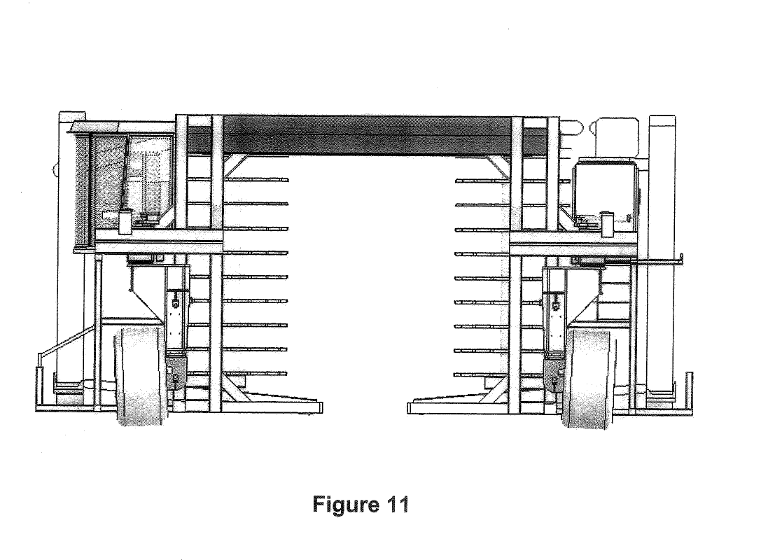

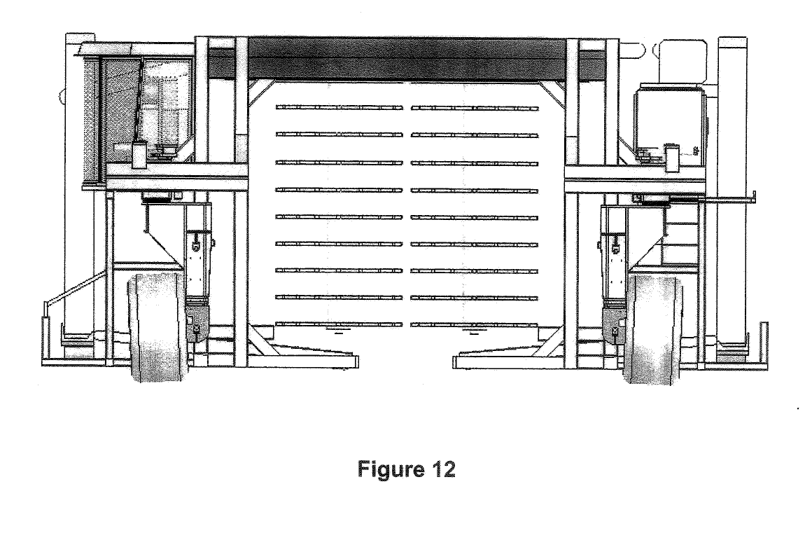

Each pinion P1, P2 and P3 will drag each crown C1, C2 and C3 with a chain symbolized with lines 13, thus generating a “T” tension as shown in FIG. 8. The tension in the parallel strand of the chain is deemed to be insignificant as regards the “T” value tension.

Said T tension will generate a moment as regards the turning center 02 of “M=T.r”, wherein “r” is the radius of crown Ci.

Since the star has three arms, the total moment generated in the weight system will be triple, i.e. “M=3.T.r”.

Should the star be able to turn around the turning center 01 (not being braked), it will start spinning around that point and the chains will stay motionless, acting as if they were a stiff element. The weights will be positioned at the furthest point from 02 by centrifugal force, as shown in FIG. 8.

If the star were braked by an external medium, the star has a braking means coupled in the machine and the axle that contains the rods, weights 9a, 9b and 9c start spinning around the turning center 02, at W1 angular speed. The more braked the star works, i.e. the lower the W2 angular speed is, the higher the increment of W1 speed value will be.

When the star comes to a complete standstill, the W2 angular speed=0, the W1 turning speed will be:

“W1=hydraulic engine speed×24/18”

In this case, as it is a weight that turns with an eccentricity that will be called R2, a centrifugal force (centripetal) appears with the following module:

“F=(m.w₁².R₂)”

The direction thereof is variable with time according to the senoid law:

“F=(m.w₁².R₂).sen(w₁t)”

t being time.

The moment as regards point 01 is:

“M=F.R₁=m.w₁².R₂).sen(w₁t).R₁”

The maximum moments are given for the positions of wt=90 (in a direction) and wt=20 for the opposite direction, i.e. where the value of sine is 1.

Said moments generated with the maximum value are the ones that provoke the oscillation of star 6 and thus of the rod system 2.

From the power delivered by the engine (at W speed), part is invested in making the star turn (and thus the brush (W2) and another part in making the weights 9 turn (at W1 speed) and thus the rods oscillate.

For this reason, if W2=0 (the star is absolutely braked so that it does not turn) all the power is invested in making masses “m” turn (W1 maximum) and thus the knocking force is maximum.

On the other hand, if the brake is absolutely released form the star, W2 is maximum and W1=0 (the “m” masses stay motionless at their farthest point from the turning center; in this case, the brushes turn at W2 speed, but without knocks (due to the fact that masses “m” are at a rest). In intermediate braking solutions, intermediate values are obtained.

Generally, the brakes and the relation between the teeth in the crowns are adjusted so that the turning speed of the brushes (W2) has a tangential value equal to the forward motion speed of the machine (obtained with W2=5 to 6 rpm).

Preferably, rod 3 is pressed between two plates on one end, which makes them oscillate while turning, defining a double action on the branches: not only does the machine knock them when turning, but it also shakes them with its vibration, remarkably improving the harvesting yield.

Said elastic behavior transfers the kinetic energy thereof to the olive tree branches, shaking them and causing the falling off of the fruits. In general, the transfer of energy is intended to be the softest possible so as not to break the branches or harm the fruit; the material with which the rod is made (polyamide) helps.

The above is one of the features that renders the machine proposed herein especially qualified to harvest olives, and sensibly surpasses the coffee machines usually used for this purpose.

In a preferred embodiment of this harvesting machine, the position of the headers or trucks 2 can be adjusted for they are mounted on trucks that move on wheels which slide on rails mounted to that end and actuated by hydraulic cylinders, thus increasing or diminishing the width of the harvesting frame; this allows for adaptation of the machine, especially the header, to the canopying of the trees and the features of the plant to be harvested, depending on their size and frondescence.

With the width of the frame defined as stated above, the operator steers the machine so as to place itself in front of the first plant, thus placing it between both headers (2). When they get in contact with the tree branches, the rods (3) hit the branches while rotating and at the same time the oscillation of each rod provides an additional shaking effect that sensibly improves yield. Improved yield is to be understood as the capacity of the machine to reap off a larger number of fruits from the plant and keep them at a reachable distance, thus avoiding the possibility of losing the ones falling on the ground.

The combined effects of the rotating and oscillating rods on the tree branches make the fruits reap off and fall due to gravity. Below the said rollers, the collecting trays prevent the fruits from reaching the ground collecting them by traditional devices for later treatment.

As expressed above, the headers are located in a structure that slides on rails that enable the rotovibrating brushes (rods) to run perpendicularly to the movement of the machine. This is an innovative design in two respects for, on the one hand, it allows for adaptation to the canopying of the trees and, on the other, it makes it possible to place the brushes within the branches without causing any damage due to the fact that the agronomic shape of the tree is respected.

The movement of said harvesting headers (trunks) can be either a) converging, from the brushes inwards; b) diverging, from the brushes outwards, c) alternate movement of both in the same direction (both to the right or both to the left), or d) movement of one or other at will, while the rest stay at a standstill.

As regards the braking of the star, which shall be uniform throughout the harvesting process and essential for the masses or weights to perform the hitting movement of the rods, it can be attained in two different ways:
a) By attaching a brake disk similar to those used in racing cars (it is bigger and has better performance features than conventional automobile ones)
b) By coupling an hydraulic motor to the star (and thus to the central brush) by a transmission element (chain of rollers) that works by providing counter-pressure to the system (in fact, the motor acts as a pump) which results in the braking of the system. According to the way a valve closes in the system, this will brake more or less the hydraulic circuit (absorbing more or less energy than the hydraulic system). According to the way the brake valve opens or closes, the star and central brush will be braked more or less, thus the knock will be more or less intense.

What is claimed is:

1. A rotovibrating device applicable to the knocking down rod headers of a harvesting machine comprising:
a frame;
rotating headers or rollers;
said frame holding the sheaders or rollers;
wherein each of the headers or rollers has a vertical axle;
wherein each vertical axle is radially in contact with a plurality of rods;
said rods capable of being in physical contact with branches of a plant to be harvested;
each of said headers or rollers comprising:
a weight support unit; and
at least three eccentric weights;
wherein each eccentric weight is capable of turning on an independent axle;
wherein each eccentric weight is laid on an equidistant vertex of the weight support unit;
wherein each eccentric weight is in connection with a respective crown;
said respective crown receiving movement from a pertinent pinion located on the vertical axle; and
a brake system that is capable of braking the weight support unit and the header or roller, thereby attaining rotation of the eccentric weights on their turning independent axles.

2. The rotovibrating device of claim 1;
wherein said weight support unit has the shape of a star, said star having three vertexes.

3. The rotovibrating device of claim 1;
wherein said respective crown and said pertinent pinion are connected to each other by means of roller chains.

4. The rotovibrating device of claim 1;
wherein said brake system is actuated in a uniform manner so as to have the turning speed of the headers or rollers achieve a tangential value equal to the forward-motion speed of the harvesting machine.

5. The rotovibrating device of claim 1;
said brake system comprising:
an hydraulic brake;
said hydraulic brake comprising:
an hydraulic motor that exercises a counter-pressure on the harvesting machine so as to achieve deceleration of the weight support unit.

6. The rotovibrating device of claim 1;
wherein said brake system comprises a disk brake.

7. The rotovibrating device of claim 1;
wherein the headers or rollers are capable of moving perpendicularly to the forward-moving direction of the harvesting machine, thereby allowing for penetration into the tree;
said perpendicular movement comprising:
a converging or diverging of the headers or rollers from one another,
moving the headers or rollers in the same direction; or
independently moving at least one header or roller at will, while the remaining headers or rollers remain motionless.

8. A rotovibrating device applicable to the knocking down rod headers of a harvesting machine comprising:
a frame;
more than one header;
wherein the header is attached to the frame;
the header having a vertical axle;
the vertical axle being in contact with a plurality of rods;
a weight support unit comprising:
at least three eccentric weights;
each weight having its own independent axle;
each eccentric weight being capable of turning on its independent axle;
wherein the eccentric weights are laid on equidistant vertexes of the weight support unit;
wherein each eccentric weight is in connection with a respective crown, said crown receiving movement from a pertinent pinion located on the vertical axle; and
a brake system capable of braking the weight support unit and the header, thereby attaining rotation of the eccentric weights on their independent axles.
